(19) United States
(12) Patent Application Publication
(10) Pub. No.: US 2013/0215759 A1
(43) Pub. Date: Aug. 22, 2013

(54) METHOD, UE AND BASE STATION FOR SENDING OR RECEIVING FEEDBACK INFORMATION OF DOWNLINK DATA

(71) Applicant: FUJITSU LIMITED, (US)

(72) Inventors: Yi WANG, Beijing (CN); Yuanrong LAN, Beijing (CN); Hua ZHOU, Beijing (CN); Jianming WU, Beijing (CN)

(73) Assignee: FUJITSU LIMITED, Kawasaki-shi (JP)

(21) Appl. No.: 13/846,042

(22) Filed: Mar. 18, 2013

Related U.S. Application Data
(63) Continuation of application No. PCT/CN2010/077397, filed on Sep. 28, 2010.

(51) Int. Cl. H04W 24/08

(52) U.S. Cl. CPC H04W 24/08
USPC 370/241

(57) ABSTRACT

A method for sending feedback information of downlink data, which is applied to a user equipment in a multi-carrier wireless communication system, including: receiving downlink data sent on a plurality of downlink component carriers by a base station; detecting whether the downlink data are correctly received on the plurality of downlink component carriers respectively, and generating a plurality of acknowledge signals corresponding to the plurality of component carriers according to detection results; and selecting corresponding Physical Uplink Control CHannel (PUCCH) resources to send the feedback information of the downlink data to the base station according to correspondence relationship between the total number of the plurality of acknowledge signals and the maximum Component Carrier index number that is configured, wherein the feedback information comprises the total number of the plurality of acknowledge signals.

### CROSS REFERENCE TO RELATED APPLICATIONS

The application is based on the PCT Application No. PCT/CN2010/077397, filed on Sep. 28, 2010 and entitled “Method, UE and based station for sending or receiving feedback information of downlink data.” The content of the application is incorporated herein by reference.

### FIELD OF THE INVENTION

The invention generally relates to transmission technique in a wireless communication system, and particularly to a transmission method for uplink feedback of correct/wrong information in a Multi-Carrier System, and specially to a method for receiving and sending feedback information of downlink data which is applied in a device (such as a base station and a user equipment) of the wireless communication system, the feedback information herein is an ACKnowledge signal (ACK)/Non-ACKnowledge signal (NACK).

### BACKGROUND OF THE INVENTION

In order to improve the reliability of data transmission, technique of Hybrid Automatic Repeat reQuest (HARQ) is usually utilized in the wireless communication system, and the HARQ is achieved mainly by techniques of Automatic Repeat reQuest (ARQ) and Forward Error Correction (FEC). In practical application, a receiving end (such as a terminal) firstly determines, by Cyclical Redundancy Check (CRC), whether the data sent by a sending end (such as a base station) are received correctly; if received correctly, the receiving end replies ACK data; if an error is found, the receiving end can reply NACK data and make an ARQ to request to resend the data which are not received correctly.

In a Long Term Evolution (LTE) system and an LTE-Advanced uplink system, the above technique of HARQ is utilized to improve the reliability of data transmission. A User Equipment (UE) in the LTE system makes CRC when the data are received; if the data are received correctly, the user equipment replies ACK data; if an error is found, the user equipment sends a request to a base station (eNB) for resending the data; the base station resends the data to the UE after receiving the request.

FIG. 1 is a flow chart of a downlink HARQ which is commonly used in the wireless communication system. As shown in FIG. 1, at the sending end (such as a base station, an eNB etc), the data are sent to the user equipment by means of a sending antenna after the data are channel-encoded and modulated. At the receiving end (such as a UE), the data are demodulated and channel-decoded, and a CRC check is made to the data to determine whether the data are received correctly; if received correctly, ACK information is generated; if received incorrectly, NACK information is generated. Also, the UE feeds back the ACK/NACK information to the base station/eNB on a Physical Uplink Control CHannel (PUCCH).

In the LTE-Advanced system, in order to improve peak rate, technique of Carrier Aggregation (CA) is also utilized in data transmission between the eNB and the UE, i.e. the data can be sent or received simultaneously on multiple Component Carriers (CC). When there are multiple CCs operating on a downlink, the UE will receive the data on multiple CCs and determine whether the data are received correctly on individual CCs. The UE processes determination results about the above multiple CCs according to a predetermined method, and delivers information of the determination results (i.e. the ACK/NACK data) to the eNB by the PUCCH of one uplink CC.

FIG. 2 is a flow chart of a downlink HARQ which is applicable to the CA. As shown in FIG. 2, at a sending end (such as a base station, an eNB), the data are sent to a UE on individual dispatched downlink CCs by means of a sending antenna after the data are channel-encoded and modulated. At a receiving end (such as a UE), the information of the dispatched downlink CC is obtained according to control information in a Physical Downlink Control CHannel (PDCCH); the data are demodulated and channel-decoded on the dispatched downlink CC, and a CRC check is made to the data to determine whether the data are received correctly; if received correctly, ACK information is generated; if received incorrectly, NACK information is generated. The UE then combines the ACK/NACK information and then feeds back them to the base station/eNB by the PUCCH of a Primary Uplink Carrier (PCC).

There are multiple ways to process the determination results about multiple CCs. One of the multiple ways is a channel selection method based on an LTE Time Division Duplexing (TDD) system, which adopts channel resources of different PUCCHs and different constellation points of modulating symbols to represent the feedback information on whether the data on all the downlink CCs are received correctly or not; however, the above way can only support the feedback information for 4 downlink CCs that the data are received correctly or not, whereas the current LTE-Advanced system is required to support the feedback information for up to 5 downlink CCs that the data are received correctly or not, and when the above way is applied to the LTE-Advanced system, all cases can not be distinguished according to the feedback information of the downlink data which is fed back by the UE, and the eNB can not know, from the feedback information about reception of the downlink data, the correct situation when the UE receives the downlink data.

As for adopting in the LTE TDD system a feedback way of making “logic AND” operations on the multiple downlink CCs, the similar problem exists. This feedback way can not be directly applied to the current LTE-Advanced system, since in the LTE-Advanced system there is no information of the number of the dispatched downlink CCs and no Downlink Assignment Indication (DAI) (i.e. a counter) in the downlink control information.

In summary, how to send the feedback information about multiple downlink CCs to the eNB in the LTE-Advanced system is a technical problem which needs to be solved urgently.

### SUMMARY OF THE INVENTION

In view of the above, one object of the invention is to provide a method for sending feedback information of downlink data so as to achieve sending the feedback information about multiple downlink CCs to an eNB in a Multiple-Carrier Wireless Communication System, and accordingly provide a user equipment which can send the feedback information of the downlink data.

Another object of the invention is to provide a method for receiving feedback information of downlink data, and accordingly provide a base station which can receive the feedback information of the downlink data, and provide a multi-carrier wireless communication system including the base station and the user equipment.

According to one aspect of the invention, there is provided a method for sending feedback information of downlink data, which is applied to the user equipment of the multi-carrier wireless communication system. In the method, corresponding PUCCH resources are selected to send the feedback information of the downlink data to an eNB, according to correspondence relationship between the total number of the multiple ACKs and the maximum CC index number that is configured; the feedback information includes the total number of the multiple ACKs.

According to another aspect of the invention, there is provided a user equipment applicable to a multi-carrier wireless communication system, a feedback information sending module in the user equipment can select corresponding PUCCH resources to send the feedback information of the downlink data to an eNB, according to correspondence relationship between the total number of the ACKs corresponding to the multiple CCs and the maximum CC index number that is configured; the feedback information includes the total number of the ACKs.

According to another aspect of the invention, there is provided a method for receiving feedback information of downlink data, which is applied to a base station of a multi-carrier wireless communication system, the method includes: sending downlink data to a user equipment on multiple downlink CCs; receiving feedback information of the downlink data sent by the user equipment, wherein the feedback information of the downlink data includes the total number of the multiple ACKs corresponding to the multiple CCs; selecting, by the user equipment, corresponding PUCCH resources to send the feedback information of the downlink data to an eNB, according to correspondence relationship between the total number of the multiple ACKs and the maximum CC index number that is configured.

According to another aspect of the invention, there is provided a base station which is applicable to a multi-carrier wireless communication system, the base station includes: a sending module, which is configured to send data to a user equipment on multiple downlink CCs; a receiving module, which is configured to receive the feedback information of the downlink data sent by the user equipment, wherein the feedback information of the downlink data includes the total number of multiple ACKs corresponding to the multiple CCs, and the user equipment selects corresponding PUCCH resources to send the feedback information of the downlink data to an eNB according to correspondence relationship between the total number of the multiple ACKs and the maximum CC index number that is configured.

According to still another aspect of the invention, there is provided a multi-carrier wireless communication system including: a base station, which is configured to send downlink data to a user equipment on multiple downlink CCs, and receive the feedback information of the downlink data sent by the user equipment, wherein the feedback information of the downlink data includes the total number of multiple ACKs corresponding to the multiple CCs; the user equipment selects corresponding PUCCH resources to send the feedback information of the downlink data to an eNB according to correspondence relationship between the total number of the multiple ACKs and the maximum CC index number that is configured; and a user equipment, which is configured to detect whether the data are received correctly on the multiple downlink CCs respectively, generate multiple ACKs corresponding to the multiple CCs according to detection results, and select corresponding PUCCH resources to send the feedback information of the downlink data to an eNB according to correspondence relationship between the total number of the multiple ACKs and the maximum CC index number that is configured, wherein the feedback information includes the total number of the multiple ACKs.

The method for sending and receiving feedback information of downlink data according to the invention avoids the phenomena in prior art that the CCs on which the data are received correctly by the UE can not be distinguished and identified correctly, achieves sending the feedback information of the downlink data by the UE in the multi-carrier wireless communication system, and also enables the eNB which receives the feedback information of the downlink data can accurately obtain the information about the CCs on which the downlink data are received correctly by the UE.

Other aspects of the invention are given in the specification part hereinafter. In the specification part, the detail illustration is only for sufficiently disclosing the preferred embodiments of the invention, without any limitation to the invention.

### BRIEF DESCRIPTION OF THE DRAWINGS

The above and other objects and advantages of the invention are further described hereinafter in conjunction with specific embodiments and drawings. In the drawings, the same or corresponding technical features or components are represented by the same or corresponding reference numerals.

FIG. 1 is a schematic flow chart of a downlink HARQ which is commonly used in a wireless communication system;

FIG. 2 is a schematic flow chart of a downlink HARQ which is applicable to CA;

FIG. 3 is a flow chart showing sending and receiving of feedback information of downlink data according to the invention;

FIG. 4 is another flow chart showing sending and receiving of feedback information of downlink data according to the invention;

FIG. 5 is still another flow chart showing sending and receiving of feedback information of downlink data according to the invention;

FIG. 6 is a structural schematic diagram of a user equipment according to the invention;

FIG. 7 is a structural schematic diagram of a base station according to the invention; and

FIG. 8 is a structural schematic diagram of a multi-carrier wireless communication system according to the invention.

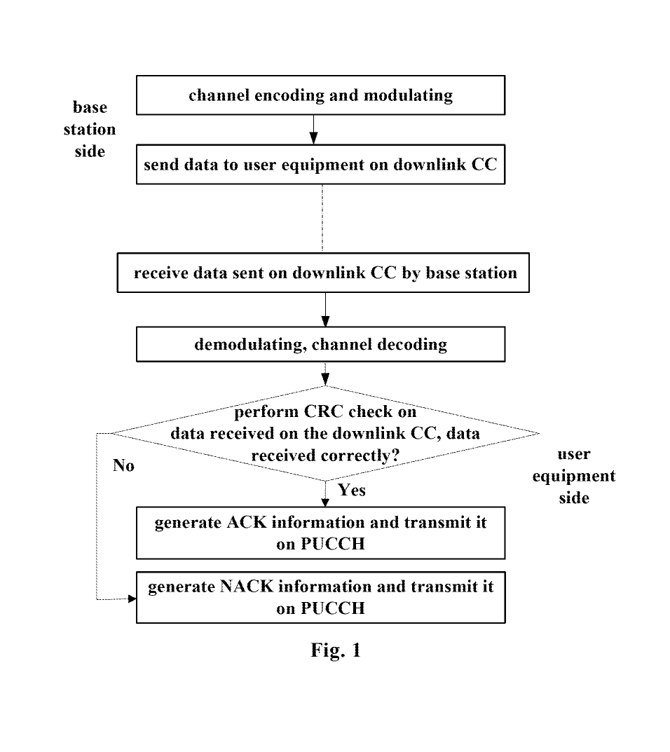

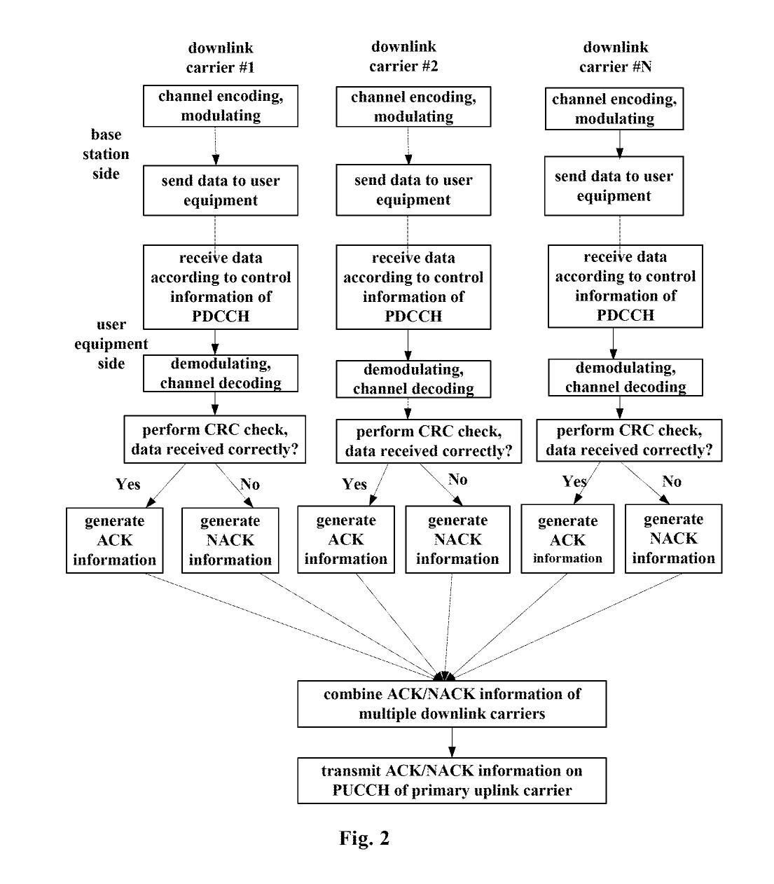

### DETAILED DESCRIPTION OF THE INVENTION

The embodiments of the invention will be illustrated hereinafter with reference to the drawings.

According to an embodiment of the invention, in a multi-carrier wireless communication system (such as an LTE-Advanced system), in the case that a UE needs to send feedback information of downlink data to an eNB, the UE selects corresponding PUCCH resources to send the total number of multiple ACKs to the eNB according to the magnitude relationship between the maximum CC index number that is configured currently and the total number of multiple ACKs which needs to be fed back by the UE. Selecting PUCCH resources can be understood as: the UE selects PUCCH resources corresponding to a downlink CC among the currently-configured multiple downlink CCs to send the feedback information of the downlink data. Specifically, after the UE receives the downlink data sent by the eNB on the multiple downlink CCs, the UE needs to detect whether the downlink data are received correctly on the multiple downlink CCs respectively, and generate multiple ACKs corresponding to the multiple CCs according to detection results; and finally the UE selects corresponding PUCCH resources to send the feedback information of the downlink data to the eNB according to correspondence relationship between the total number of the multiple ACKs and the maximum CC index number that is configured; the feedback information can include the total number of the multiple ACKs.

Accordingly, the way of receiving the feedback information of the downlink data at the eNB side is as follows: after sending data to a user equipment on multiple downlink CCs, the eNB receives the feedback information of the downlink data sent by the user equipment; the feedback information of the downlink data includes the total number of the multiple ACKs corresponding to the multiple CCs; the user equipment selects corresponding PUCCH resources to send the feedback information of the downlink data to the eNB, according to correspondence relationship between the total number of the multiple ACKs and the maximum CC index number that is configured.

It should be illustrated that, in the multi-carrier wireless communication system, since the maximum number of CCs that is configured may be any number among 2˜8, e.g. the configured maximum number of the CCs is 5 or 8 or the like, the UE needs to select a digital modulating mode of QPSK or a digital modulating mode of BPSK according to the magnitude of the configured maximum number of the CCs; at this time, what is sent finally by the UE is the constellation points of QPSK or BPSK, but there is one-to-one correspondence relationship between the constellation points and the total number of the multiple ACKs, so that the eNB can know how many downlink carriers on which the data are received correctly when the eNB receives the feedback information of the downlink data sent by the UE. In the case of different configured maximum numbers of CCs, the specific embodiments to achieve the invention are different. The invention relates to a method and a user equipment for sending feedback information of uplink data in a multi-carrier wireless communication system, a method and a base station for receiving the feedback information of the uplink data in the multi-carrier wireless communication system, and the whole multi-carrier wireless communication system, which selects and utilizes the PUCCH resources at the user equipment side to send the feedback information of the downlink data to the base station, so that the base station can obtain the correct situation about the receiving of the downlink data at the user equipment side after analyzing the feedback information.

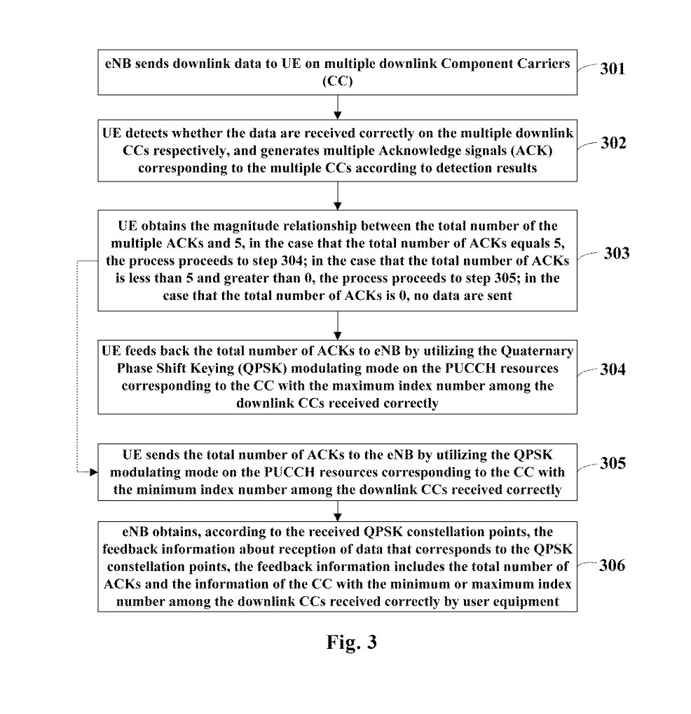

Firstly, the implementation process of the invention in practical application is illustrated hereinafter by an example in which the configured maximum number of CCs is 5. Referring to FIG. 3, which is a flow chart of an embodiment according to the invention, the embodiment can specifically include the following steps:

step 301: sending, by an eNB, downlink data to a UE on multiple downlink CCs.

In the present embodiment, the configured maximum index number of CC is 5, i.e. the eNB can simultaneously send the downlink data to the UE on up to 5 CCs, including CC1, CC2, CC3, CC4 and CC5; where, CC1 represents a downlink CC the index number of which is 1, and so on, CC5 represents a downlink CC the index number of which is 5.

Step 302: detecting, by the UE, whether the downlink data are received correctly on the multiple downlink CCs respectively, and generating multiple ACKs corresponding to the multiple CCs according to detection results.

Since it is possible that the downlink data sent on each of the CCs may not be correctly received by the UE, the UE needs to detect whether the data are received correctly on each downlink CC respectively. In detection, a CRC checking way can be utilized to determine the number of CCs on which the data are received correctly. For example, in the present embodiment, it is determined that the data are received correctly on CCs the index number of which is respectively 1, 3 and 4, or that the data are received correctly on CCs the index number of which is 2 and 5, and so on. If no data are received on any CC by the UE, or no data are sent to the UE on the downlink CCs, no ACK will be generated at the UE side, i.e. the total number of the ACKs is 0.

Step 303: obtaining, by the UE, magnitude relationship between the total number of the multiple ACKs and 5, wherein in the case that the total number of ACKs equals 5, the process proceeds to step 304; in the case that the total number of ACKs is less than 5 and greater than 0, the process proceeds to step 305; in the case that the total number of ACKs equals 0, no data are sent.

After generating multiple ACKs corresponding to the multiple downlink CCs on which the data are sent, it is required to compare the total number of the ACKs with the maximum CC index number that is configured, so as to select the corresponding resources subsequently according to a comparison result, i.e. the feedback information of the downlink data are sent on which CC. Since in the present embodiment the CC with the configured maximum index number is CC5, there are six cases in total about the total number of the ACKs which may be generated in the UE, i.e. the total number of the ACKs is 0, 1, 2, 3, 4 and 5 respectively.

Step 304: feeding back, by the UE, the total number of ACKs to the eNB by utilizing a Quaternary Phase Shift Keying (QPSK) modulating mode on the PUCCH resources corresponding to the CC with the maximum index number among the CCs received correctly.

In the case that the total number of the ACKs equals 5, the downlink data sent on all the configured 5 CCs by the eNB are correctly received by the UE, the UE sends the feedback information of “5” to the eNB by utilizing the QPSK modulating mode when the UE feeds back the total number of ACKs to the eNB. Specifically, the UE selects PUCCH resources corresponding to CC5 (i.e. the CC with the maximum index number among the downlink CCs received correctly) to send the feedback information of the downlink data; however, since the QPSK mode is selected and the QPSK symbols have only four states, the way in which there is one-to-one correspondence relationship between the QPSK constellation points, the total number of the ACKs and the PUCCH resources can be utilized for processing, so that when the eNB receives the QPSK constellation points sent by the UE, the eNB can uniquely determine, according to the selected PUCCH resources, the total number of CCs on which the downlink data are received correctly by the UE.

Step 305: feeding back, by the UE, the total number of the ACKs to the eNB by utilizing the QPSK modulating mode on the PUCCH resources corresponding to the CC with the minimum index number among the downlink CCs received correctly.

In the case that the total number of the ACKs is less than 5 and greater than 0, this indicates that the downlink data are received correctly by the UE only on a part of the CCs among the 5 configured downlink CCs; at this time, the UE needs to feed back the total number of ACKs to the eNB by utilizing the QPSK modulating mode on PUCCH resources corresponding to the CC with the minimum index number among the downlink CCs received correctly. For example, when the UE receives the data on CC1 and CC3 correctly, the UE needs to send QPSK constellation points, which uniquely correspond to the total number of ACKs (i.e. 2), to the eNB on the CC1; for example, when the UE receives the data on CC2, CC4 and CC5 correctly, the UE needs to send QPSK constellation points, which uniquely correspond to “3”, to the eNB on the CC2.

It should be illustrated that, the above-described unique correspondence relationship between the QPSK constellation point and the total number of the ACKs can be set in advance, and the correspondence relationship can be stored at both the UE side and the eNB side in advance. Furthermore, in the present embodiment, the QPSK constellation points utilized when the total number of the multiple ACKs equals 1 are different from the QPSK constellation points utilized when the total number of the ACKs is any number among 2˜5; and the QPSK constellation points utilized when the total number of the ACKs equals 5 are different from the QPSK constellation points utilized when the total number of the ACKs is any number among 2˜4. Referring to table 1, the relationship between the total number of ACKs, the QPSK symbols and the PUCCH resources selected by the UE in the present embodiment is shown. In table 1, the first column “total number of the ACKs” represents six cases in which the UE may send different feedback information in the present embodiment, the second column “QPSK” represents the correspondence relationship between the QPSK symbols utilized by the UE and the total number of ACKs, and the third column “PUCCH resources” represents the criterion for selecting PUCCH resources in the case of meeting the above total number of ACKs and the QPSK symbols.

TABLE 1

| total number | | |
|---|---|---|
| of ACKs | QPSK | PUCCH resources |
| 0 | | no signal is sent |
| 1 | 0, 0 | resources corresponding to the CC with the minimum index number |
| | | among the downlink CCs received correctly |
| 2 | 1, 1 | resources corresponding to the CC with the minimum index number |
| | | among the downlink CCs received correctly |
| 3 | 1, 0 | resources corresponding to the CC with the minimum index number |
| | | among the downlink CCs received correctly |
| 4 | 0, 1 | resources corresponding to the CC with the minimum index number |
| | | among the downlink CCs received correctly |
| 5 | 1, 1 | resources corresponding to the CC with the maximum index number |
| | | among the downlink CCs received correctly |

Since the QPSK symbols have four states in total: (0,0), (0,1), (1,0) and (1,1), when the relationship between the total number of ACKs, the QPSK constellation points and the PUCCH resources is set in advance, only two principles should be met: the first principle is that the QPSK constellation points utilized when the total number of ACKs equals 1 are different from the QPSK constellation points utilized when the total number of ACKs is any number among 2˜5; the second principle is that the QPSK constellation points utilized when the total number of ACKs equals 5 are the same as any QPSK constellation point utilized when the total number of ACKs is any number among 2˜4. Therefore, the correspondence relationship that meets the above two principles can also be shown as table 2.

TABLE 2

| total number | | |
|---|---|---|
| of ACKs | QPSK | PUCCH resources |
| 0 | | no signal is sent |
| 1 | 0, 0 | resources corresponding to the carrier with the minimum index number |
| | | among the downlink carriers which have been received correctly |
| 2 | 1, 1 | resources corresponding to the carrier with the minimum index number |
| | | among the downlink carriers which have been received correctly |
| 3 | 1, 0 | resources corresponding to the carrier with the minimum index number |
| | | among the downlink carriers which have been received correctly |
| 4 | 0, 1 | resources corresponding to the carrier with the minimum index number |
| | | among the downlink carriers which have been received correctly |
| 5 | 1, 0 | resources corresponding to the carrier with the maximum index number |
| | | among the downlink carriers which have been received correctly |

Or the correspondence relationship that meets the above two principles can also be shown as table 3

TABLE 3

| total number | | |
|---|---|---|
| of ACKs | QPSK | PUCCH resources |
| 0 | | no signal is sent |
| 1 | 1, 0 | resources corresponding to the carrier with the minimum index number |
| | | among the downlink carriers which have been received correctly |
| 2 | 0, 0 | resources corresponding to the carrier with the minimum index number |
| | | among the downlink carriers which have been received correctly |
| 3 | 0, 1 | resources corresponding to the carrier with the minimum index number |
| | | among the downlink carriers which have been received correctly |
| 4 | 1, 1 | resources corresponding to the carrier with the minimum index number |
| | | among the downlink carriers which have been received correctly |
| 5 | 1, 1 | resources corresponding to the carrier with the maximum index number |
| | | among the downlink carriers which have been received correctly |

In summary, it should be appreciated by those skilled in the art that, table 1, 2 and 3 are only several examples of the present embodiment, and it is obvious that tables included in other examples which meet the above two principles fall within the scope of protection of the invention.

It should be illustrated that, in the multi-carrier wireless communication system, in the case that the maximum number of CCs can be configured to be 5, but in practical application for specific eNB and UE, the number of CCs is not necessarily configured to be the maximum value 5, it may be configured to be 2, 3 or 4. For the case that the number of CCs actually configured is any natural number among 2˜4, the same principle as that used in the case that the maximum number of CCs is 5 is utilized to send the feedback information of the downlink data. For example, if the principle for sending the feedback information of the downlink data that is appointed by the eNB and the UE is that: it needs to follow the condition shown in table 1 in the case that the configured maximum number of CCs is 5, in the case that the number of CCs actually configured is 2, 3 or 4, the UE also needs to send the feedback information of the downlink data according to table 1, and the eNB side also needs to receive and obtain the feedback information according to the principle shown in table 1.

Step 306: obtaining, by the eNB, the feedback information about reception of data that corresponds to the QPSK constellation points, according to the received QPSK constellation points, wherein the feedback information includes the total number of ACKs and the information of the CC with the minimum or maximum index number among the downlink CCs received correctly by the user equipment.

In the case that the maximum number of CCs can be configured to be 5, for individual embodiments corresponding to the case that the number of CCs actually configured in application is any natural number among 2˜4, since the same principle is followed as the case that the configured maximum number of CCs is 5, the sending of the feedback information of the downlink data at the UE side can also be performed according to the flow of the above steps 301 to 306, which will not be described in detail herein.

In the present embodiment, the representation of the total number of ACKs is achieved specifically by feeding back the QPSK constellation points by the UE. Therefore, after the eNB receives the QPSK constellation points, the eNB needs to obtain the total number of ACKs corresponding to the QPSK constellation points and the information of the CC with the minimum or maximum index number among the downlink CCs received correctly by the user equipment, according to the correspondence relationship shown in the above tables. For example, if the total number of ACKs which is sent on CC1 by the user equipment is 2, the eNB will know that the user equipment receives data correctly at least on CC1, and also receives data correctly on another CC at the same time.

According to the method for sending the feedback information of the downlink data by the UE disclosed in the present embodiment, in the case that the eNB receives the feedback information, the eNB can correctly identify how many CCs the data are received on correctly by the UE, and can at least identify on which CC the data are received correctly; and for the eNB, misidentification will not occur between feedback information from the UE, therefore, the method achieves correctly sending the feedback information of the downlink data at the UE side, and meanwhile improves the detection performance of the data reception situation of the UE at the eNB side. It should be illustrated that, if the configured maximum index number of CC is 4, the feedback information of the downlink data can also be sent by using the correspondence relationship disclosed in the tables of the present embodiment.

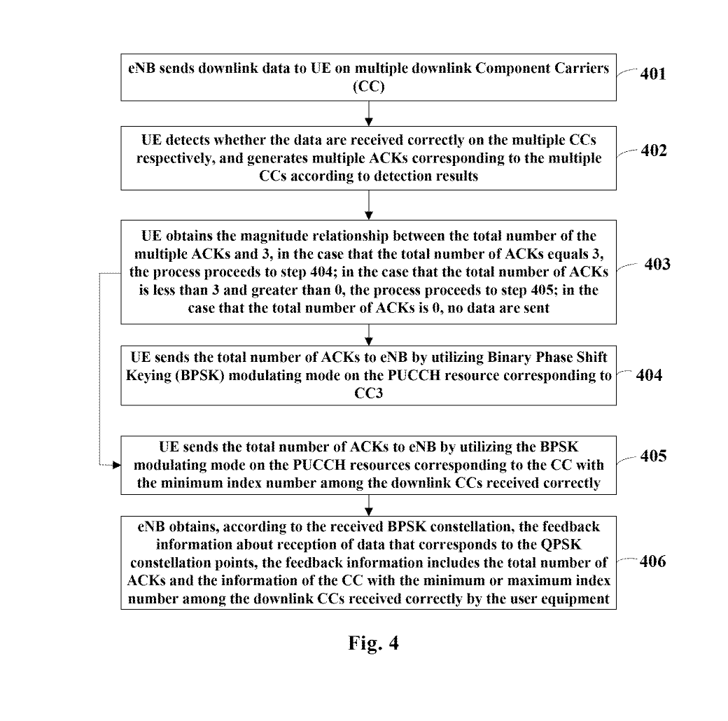

The implementation process of the invention in practical application will be illustrated hereinafter by an example in which the configured maximum number of CCs is 3. Referring to FIG. 4 which shows a flow chart of a second embodiment according to the invention, the present embodiment can specifically include the following steps:

step 401: sending, by an eNB, downlink data to a UE on multiple downlink CCs.

In the present embodiment, the configured maximum number of CCs is 3, i.e. the eNB can simultaneously send the downlink data to the UE on up to 3 CCs, including CC1, CC2 and CC3.

Step 402: detecting, by the UE, whether the downlink data are correctly received on the multiple downlink CCs respectively, and generating multiple ACKs corresponding to the multiple CCs according to detection results.

In the present embodiment, if the UE correctly received the data on CC1 and CC3, then at this time one ACK corresponding to CC1 and one ACK corresponding to CC3 are generated according to the detection result, i.e. the total number of ACKs equals 2. Of course, there are a number of cases for the UE in the present embodiment, for example, the UE receives the data correctly on CC1 and CC2, or no data are received by the UE on any one of the 3 CCs, and so on.

Step 403: obtaining, by the UE, the magnitude relationship between the total number of the multiple ACKs and 3, wherein in the case that the total number of ACKs equals 3, the process proceeds to step 404; in the case that the total number of ACKs is less than 3 and greater than 0, the process proceeds to step 405; in the case that the total number of the ACK equals 0, no data are sent.

After the UE generates the total number of ACKs “2” in accordance with the two downlink CCs on which the data are received correctly, and the UE compares the total number of ACKs (i.e. 2) with the configured maximum CC index number (i.e. 3), so as to select corresponding PUCCH resources subsequently according to a comparison result, i.e. the feedback information of the downlink data are sent on which CC. Since in the present embodiment the configured CC with the maximum index number is CC3, there are four cases in total about the total number of the ACKs which may be generated by the UE, i.e. the total number of the ACKs is 0, 1, 2 and 3 respectively.

Step 404: feeding back, by the UE, the total number of ACKs to the eNB by utilizing a Binary Phase Shift Keying (BPSK) modulating mode on the PUCCH resources corresponding to CC3.

The difference between the present embodiment and the above embodiment is in that: in the present embodiment the UE feeds back the total number of ACKs to the eNB by utilizing the BPSK modulating mode. Since there are total four cases in the present embodiment, the UE can correctly distinguish the four cases by utilizing the BPSK constellation points 0 and 1, and this can also save the transmission resources of the system.

In the case that the total number of ACKs equals 3, if the UE correctly receives the downlink data sent on all the 3 configured CCs by the eNB, the UE sends the feedback information of “3” to the eNB by utilizing the BPSK modulating mode when the UE feeds back the total number of ACKs to the eNB. Specifically, the UE selects the downlink CC3 (i.e. the CC with the maximum index number among the downlink CCs received correctly) to send the feedback information of the downlink data, at the same time since the BPSK mode is selected, the way in which there is one-to-one correspondence relationship between the BPSK constellation points and the total number of the ACKs can be utilized for processing, so that the eNB can uniquely determine the total number of the CCs on which the downlink data are received correctly by the UE when the eNB receives the BPSK constellation points sent by the UE.

Step 405: feeding back, by the UE, the total number of ACKs to the eNB by utilizing the BPSK modulating mode on the PUCCH resources corresponding to the CC with the minimum index number among the CCs received correctly.

In the case that the total number of ACKs is less than 3 and greater than 0, this indicates that the downlink data are received correctly by the UE only on a part of CCs among the 3 configured downlink CCs, at this time the UE needs to feed back the total number of ACKs to the eNB by utilizing the BPSK modulating mode on PUCCH resources corresponding to the CC with the minimum index number among the CCs received correctly. For example, when the UE receives the data on CC1 and CC3 correctly, the UE needs to send the BPSK constellation points, which uniquely correspond to the total number of ACKs (i.e. 2), to the eNB on the CC1.

It should be understood that, the above-described unique correspondence relationship between the BPSK constellation points and the total number of the ACKs can also be set in advance, and the correspondence relationship can be stored at both the UE side and the eNB side in advance. Furthermore, in the present embodiment, the BPSK constellation points utilized when the total number of the ACKs corresponding to the multiple downlink CCs equals 1 are different from the BPSK constellation points utilized when the total number of the ACKs is any number among 2˜3. Referring to table 4 and table 5, the two correspondence relationships between the total number of ACKs, the BPSK symbols and the PUCCH resources selected by the UE are shown. In table 4, the first column “total number of ACKs” represents four cases in which the UE may send different feedback information in the present embodiment, the second column “BPSK” represents the correspondence relationship between the BPSK symbols utilized by the UE and the total number of ACKs, the third column “PUCCH resources” represents the criterion for selecting the PUCCH resources in the case of meeting the above total number of ACKs and the BPSK symbols.

TABLE 4

| total number | | |
|---|---|---|
| of ACKs | BPSK | PUCCH resources |
| 0 | | no signal is sent |
| 1 | 0 | resources corresponding to the carrier with the minimum index number |
| | | among the downlink carriers which have been received correctly |
| 2 | 1 | resources corresponding to the carrier with the minimum index number |
| | | among the downlink carriers which have been received correctly |
| 3 | 1 | resources corresponding to the carrier with the maximum index number |
| | | among the downlink carriers which have been received correctly |

TABLE 5

| total number | | |
|---|---|---|
| of ACKs | BPSK | PUCCH resources |
| 0 | | no signal is sent |
| 1 | 1 | resources corresponding to the carrier with the minimum index number |
| | | among the downlink carriers which have been received correctly |
| 2 | 0 | resources corresponding to the carrier with the minimum index number |
| | | among the downlink carriers which have been received correctly |
| 3 | 0 | resources corresponding to the carrier with the maximum index number |
| | | among the downlink carriers which have been received correctly |

Since the BPSK symbols have two states in total: 0 and 1, when the relationship between the total number of ACKs, the BPSK constellation points and the PUCCH resources is set in advance, only one principle should be met: the BPSK constellation points utilized when the total number of ACKs equals 1 are different from the BPSK constellation points utilized when the total number of ACKs is any number among 2˜3.

Step 406: obtaining, by the eNB, the feedback information about reception of data that corresponds to the BPSK constellation points, according to the received BPSK constellation points; the feedback information includes the total number of ACKs and the information of the CC with the minimum or maximum index number among the downlink CCs received correctly by the user equipment.

In the present embodiment, the representation of the total number of ACKs is achieved specifically by feeding back the BPSK constellation points by the UE. Therefore, after the eNB receives the BPSK constellation points, the eNB needs to obtain the total number of ACKs corresponding to the BPSK constellation points and the information of the CC with the minimum or maximum index number among the downlink CCs received correctly by the user equipment, according to the correspondence relationship shown in the above table 4 and table 5. For example, if the total number of ACKs which is sent on CC1 by the user equipment is 2, the eNB will know that the user equipment receives data correctly at least on CC1, and also receives data correctly on another CC (CC2 or CC3) at the same time.

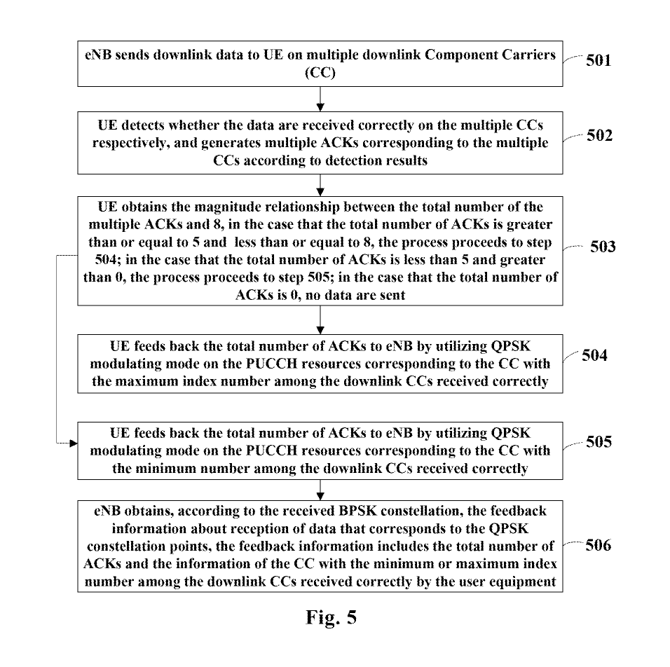

Finally, the implementation process of the invention in practical application will be illustrated by an example that the configured maximum number of CCs is 8. Referring to FIG. 5 which shows a flow chart of an embodiment according to the invention, the present embodiment can specifically include the following steps:

Step 501: sending, by an eNB, downlink data to a UE on multiple downlink CCs.

In the present embodiment, the configured maximum number of CCs is 8, i.e. the eNB can simultaneously send the downlink data to the UE on up to 8 CCs, including CC1, CC2, CC3, CC4, CC5, CC6, CC7 and CC8. Where, CC1 represents a CC the index number of which is 1, and so on, CC8 represents a CC the index number of which is 8.

Step 502: detecting, by the UE, whether the downlink data are correctly received on the multiple downlink CCs respectively, and generates multiple ACKs corresponding to the multiple CCs according to detection results.

In the present embodiment, the way that the UE detects whether the data are received correctly on the CCs and generates the ACKs corresponding to the CCs is the same as that of the above two embodiments, which will not be described in detail herein.

Step 503: obtaining, by the UE, the magnitude relationship between the total number of the multiple ACKs and 8, wherein in the case that the total number of ACKs is greater than or equal to 5 and is less than or equal to 8, the process proceeds to step 504; in the case that the total number of ACKs is greater than 0 and less than 5, the process proceeds to step 505; and in the case that the total number of ACKs equals 0, no data are sent.

After the UE generates corresponding multiple ACKs in accordance with the multiple downlink CCs on which the data are sent, the UE compares the total number of the ACKs with 8, so as to select corresponding PUCCH resources subsequently according to a comparison result, i.e. the feedback information of the downlink data are sent on which CC. Since in the present embodiment the configured maximum CC is CC8, there are nine cases in total about the total number of the ACKs which may be generated by the UE, i.e. the total number of the ACKs is 0, 1, 2, 3, 4, 5, 6, 7 and 8 respectively.

Step 504: feeding back, by the UE, the total number of ACKs to the eNB by utilizing a QPSK modulating mode on the PUCCH resources corresponding to a CC with the maximum index number among the downlink CCs received correctly.

In the case that the total number of ACKs is greater than 5 and is less than or equal to 8, i.e. the total number of CCs on which the downlink data are correctly received by the UE is 5, 6, 7 or 8, the UE sends the feedback information of 5, 6, 7 or 8 to the eNB by utilizing the QPSK modulating mode when the UE feeds back the total number of ACKs to the eNB. Specifically, the UE selects the PUCCH corresponding to CC5, CC6, CC 7 or CC8 (i.e. the CC with the maximum index number among the downlink CCs received correctly) to send the feedback information of the downlink data; for example, the number of the downlink CCs received correctly is 6, i.e. CC1 to CC6, the feedback information of the downlink data are sent on the PUCCH resources corresponding to CC6; at the same time since the selected QPSK symbols include only four states, the way in which there is one-to-one correspondence relationship between the QPSK constellation points, the total number of the ACKs and the PUCCH resources can be utilized for processing, so that when the eNB receives the QPSK constellation points sent by the UE, the eNB can uniquely determine, according to the selected PUCCH resources, the total number of the CCs on which the downlink data are received correctly by the UE.

Step 505: feeding back, by the UE, the total number of ACKs to the eNB by utilizing the QPSK modulating mode on the PUCCH resources corresponding to the CC with the minimum index number among the downlink CCs received correctly.

In the case that the total number of ACKs is less than 5 and greater than 0, this indicates that among the 8 configured downlink CCs, the total number of CCs on which the downlink data are correctly received by the UE may be 1, 2, 3, or 4; at this time the UE needs to feed back the total number of ACKs to the eNB by utilizing the QPSK modulating mode on the PUCCH resources corresponding to the CC with the minimum index number among the downlink CCs received correctly. For example, if the UE has correctly received the data on CC1 and CC7, the UE needs to send the QPSK constellation points, which uniquely correspond to the total number of ACKs (i.e. 2), to the eNB on CC1; for example, if the UE receives the data on CC2, CC6 or CC8 correctly, the UE needs to send the QPSK constellation points which uniquely correspond to “3”, to the eNB on CC2.

It should be illustrated that, the above-described unique correspondence relationship between the QPSK constellation points and the total number of the ACKs can be set in advance, and the correspondence relationship can be stored at both the UE side and the eNB side in advance. Furthermore, in the present embodiment, the QPSK constellation points utilized when the total number of the ACKs equals 1 are the same as the QPSK constellation points utilized when the total number of the ACKs equals 5; the QPSK constellation points utilized when the total number of the ACKs equals 2 are the same as the QPSK constellation points utilized when the total number of the ACKs equals 8; the QPSK constellation points utilized when the total number of the ACKs equals 3 are the same as the QPSK constellation points utilized when the total number of the ACKs equals 7; the QPSK constellation points utilized when the total number of the ACKs equals 4 are the same as the QPSK constellation points utilized when the total number of the ACKs equals 6. Then the correspondence relationship that meets the above principle is shown as table 6. In table 6, the first column “total number of ACKs” represents nine cases in the present embodiment in which the UE may send different feedback information, the second column “QPSK” represents the correspondence relationship between the QPSK symbols utilized by the UE and the total number of ACKs, and the third column “PUCCH resources” represents the principle for selecting the PUCCH resources in the case of meeting the above total number of ACKs and the QPSK symbols.

TABLE 6

| total number | | |
|---|---|---|
| of ACKs | QPSK | PUCCH resources |
| 0 | | no signal is sent |
| 1 | 0, 0 | resources corresponding to the carrier with the minimum index number |
| | | among the downlink carriers which have been received correctly |
| 2 | 1, 1 | resources corresponding to the carrier with the minimum index number |
| | | among the downlink carriers which have been received correctly |
| 3 | 1, 0 | resources corresponding to the carrier with the minimum index number |
| | | among the downlink carriers which have been received correctly |
| 4 | 0, 1 | resources corresponding to the carrier with the minimum index number |
| | | among the downlink carriers which have been received correctly |
| 5 | 0, 0 | resources corresponding to the carrier with the maximum index number |
| | | among the downlink carriers which have been received correctly |
| 6 | 0, 1 | resources corresponding to the carrier with the maximum index number |
| | | among the downlink carriers which have been received correctly |
| 7 | 1, 0 | resources corresponding to the carrier with the maximum index number |
| | | among the downlink carriers which have been received correctly |
| 8 | 1, 1 | resources corresponding to the carrier with the maximum index number |
| | | among the downlink carriers which have been received correctly |

The relationship between the total number of ACKs, the QPSK constellation points and the PUCCH resources, which meets the above principle, can also be shown as table 7.

TABLE 7

| the | | |
|---|---|---|
| total number | | |
| of ACKs | QPSK | PUCCH resources |
| 0 | | no signal is sent |
| 1 | 1, 1 | resources corresponding to the carrier with the |
| | | minimum index number among the downlink carriers |
| | | which have been received correctly |
| 2 | 1, 0 | resources corresponding to the carrier with the |
| | | minimum index number among the downlink carriers |
| | | which have been received correctly |
| 3 | 0, 0 | resources corresponding to the carrier with the |
| | | minimum index number among the downlink carriers |
| | | which have been received correctly |
| 4 | 0, 1 | resources corresponding to the carrier with the |
| | | minimum index number among the downlink carriers |
| | | which have been received correctly |
| 5 | 1, 1 | resources corresponding to the carrier with the |
| | | maximum index number among the downlink carriers |
| | | which have been received correctly |
| 6 | 0, 1 | resources corresponding to the carrier with the |
| | | maximum index number among the downlink carriers |
| | | which have been received correctly |
| 7 | 0, 0 | resources corresponding to the carrier with the |
| | | maximum index number among the downlink carriers |
| | | which have been received correctly |
| 8 | 1, 0 | resources corresponding to the carrier with the |
| | | maximum index number among the downlink carriers |
| | | which have been received correctly |

Or, the relationship between the total number of ACKs, the QPSK constellation points and the PUCCH resource, which meets the above principle, can also be shown as table 8.

TABLE 8

| the | | |
|---|---|---|
| total number | | |
| of ACKs | QPSK | PUCCH resources |
| 0 | | no signal is sent |
| 1 | 0, 1 | resources corresponding to the carrier with the |
| | | minimum index number among the downlink carriers |
| | | which have been received correctly |
| 2 | 1, 0 | resources corresponding to the carrier with the |
| | | minimum index number among the downlink carriers |
| | | which have been received correctly |
| 3 | 0, 0 | resources corresponding to the carrier with the |
| | | minimum index number among the downlink carriers |
| | | which have been received correctly |
| 4 | 1, 1 | resources corresponding to the carrier with the |
| | | minimum index number among the downlink carriers |
| | | which have been received correctly |
| 5 | 0, 1 | resources corresponding to the carrier with the |
| | | maximum index number among the downlink carriers |
| | | which have been received correctly |
| 6 | 1, 1 | resources corresponding to the carrier with the |
| | | maximum index number among the downlink carriers |
| | | which have been received correctly |
| 7 | 0, 0 | resources corresponding to the carrier with the |
| | | maximum index number among the downlink carriers |
| | | which have been received correctly |
| 8 | 1, 0 | resources corresponding to the carrier with the |
| | | maximum index number among the downlink carriers |
| | | which have been received correctly |

Step 506: obtaining, by the eNB, the feedback information about reception of data that corresponds to the QPSK constellation points, according to the received QPSK constellation points; wherein the feedback information includes the total number of ACKs and the information of the CC with the minimum or maximum index number among the downlink CCs received correctly by the user equipment.

It should be illustrated that, in the multi-carrier wireless communication system, when the maximum number of CCs that may be configured is 8, for the specific eNB and UE in practical application, the number of CCs is not necessarily configured as the maximum value 8, which can be any number among 2˜7. However, for the case that the number of CCs actually configured is any natural number among 2˜7, it is also required to use the same principle as that used in the case that the configured maximum number of CCs is 8 to send the feedback information of the downlink data. For example, if the principle for sending the feedback information of the downlink data that is appointed by the eNB and the UE is that: the condition shown in the above table 6 should be followed in the case that the configured maximum number of CCs is 8; in the case that the maximum number of CCs actually configured equals 2, 3, 4, 5, 6 or 7, the UE needs to send the feedback information of the downlink data according to the table 6, and the feedback information is also received and obtained according to the principle shown in the table 6 at the eNB side.

In the case that the maximum number of CCs may be configured is 8, for embodiments in which the number of CCs actually configured is any natural number among 2˜7, since the same principle as that used in the case that the configured maximum number of CCs is 8 is followed, the sending of the feedback information of the downlink data at the UE side can also be performed according to the flow of the above steps 501 to 506, which will not be described in detail herein.

In summary, those skilled in the art will know that, tables 6, 7 and 8 are only some examples of the present embodiment, and it is obvious that tables included in other embodiments which meet the principle of the present embodiment fall within the scope of protection of the invention.

The implementation of the invention is illustrated above by taking the interaction process of the feedback information of the downlink data between the UE and the eNB as an example, the invention utilizes a way which combines the total number of ACKs, the PUCCH resources and the modulating mode, thus avoiding the case in prior art that confusion occurs when the feedback information of the downlink data are sent. Furthermore, using the embodiments of the invention, the eNB can also correctly identify the correct reception situation of the data by the UE and improve the correct rate of distinguish.

It should be noted that, the steps for performing the series of processing described above can be naturally performed according to the order of the illustration and the time order, but they are not necessarily performed according to the time order. Some steps can be performed in parallel or independent of each other.

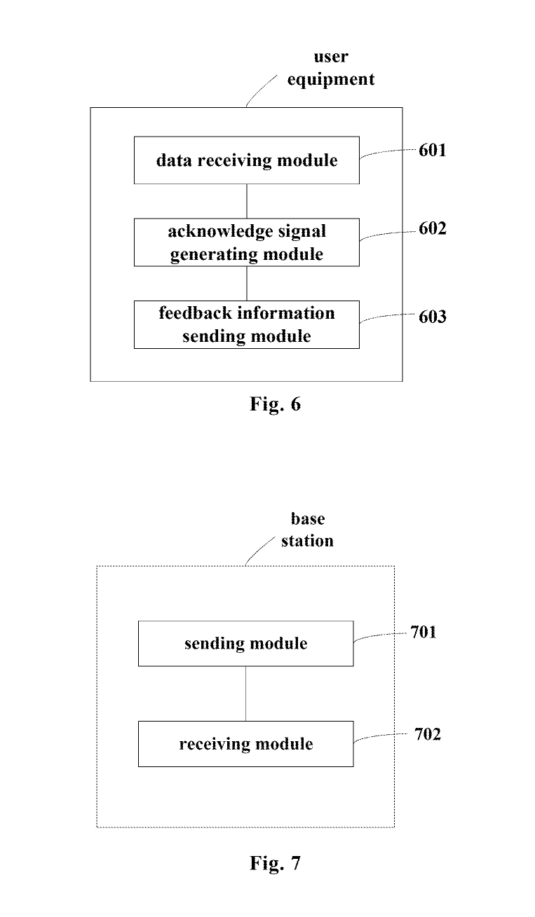

Referring to FIG. 6 which shows an embodiment of a user equipment according to the invention, the user equipment is applicable to an advanced multi-carrier wireless communication system (an LTE-Advanced system), and the user equipment specifically includes: a data receiving module 601, which is configured to receive data that is sent on multiple downlink CCs by the base station eNB; an acknowledge signal generating module 602, which is configured to detect whether the data are received correctly on the multiple downlink CCs respectively and generate multiple ACKs corresponding to the multiple CCs according to detection results; and a feedback information sending module 603, which is configured to select corresponding PUCCH resources to send the feedback information of the downlink data to the eNB, according to correspondence relationship between the total number of the ACKs corresponding to the multiple CCs and the maximum CC index number that is configured; the feedback information includes the total number of the ACKs.

In the case that the configured maximum number of CCs is 5, or in the case that the maximum number of CCs that may be configured is 5 whereas the number of CCs actually configured is any number among 2˜4, the feedback information sending module can be further configured to: in the case that the total number of ACKs equals 5, feed back the total number of ACKs to the eNB by utilizing the QPSK modulating mode on the PUCCH resources corresponding to the CC with the maximum index number among the downlink CCs received correctly; in the case that the total number of ACKs is greater than 0 and less than 5, feed back the total number of ACKs to the eNB by utilizing the QPSK modulating mode on the PUCCH resources corresponding to the CC with the minimum index number among the downlink CCs received correctly; in the case that the total number of ACKs is greater than 0 and less than 5, send no data.

It should be illustrated that, in the present embodiment, the unique correspondence relationship between the QPSK constellation points and the total number of the ACKs can be set in advance, and the correspondence relationship is stored at both the UE side and the eNB side in advance. Furthermore, in the present embodiment, the QPSK constellation points utilized when the total number of the ACKs is 1 are different from the QPSK constellation points utilized when the total number of the ACKs is any number among 2˜5; furthermore, the QPSK constellation points utilized when the total number of the ACKs is 5 can be the same as the QPSK constellation points utilized when the total number of the ACKs is any number among 2˜4.

In the case that the configured maximum number of CCs is 3, the feedback information sending module can be further configured to: in the case that the total number of ACKs equals 3, feed back the total number of ACKs to the eNB by utilizing the BPSK modulating mode on the PUCCH resources corresponding to the CC with the maximum index number among the downlink CCs received correctly; in the case that the total number of ACKs is greater than 0 and less than 3, feed back the total number of ACKs to the eNB by utilizing the BPSK modulating mode on the PUCCH resources corresponding to the CC with the minimum index number among the downlink CCs received correctly; in the case that the total number of ACKs is 0, send no data.

Since the BPSK symbols have two states 0 and 1, when the relationship between the total number of ACKs, the BPSK constellation points and the PUCCH resources is set in the UE and the eNB in advance, only one principle should be met: the BPSK constellation points utilized when the total number of ACKs is 1 are different from the BPSK constellation points utilized when the total number of ACKs is any number among 2˜3.

In the case that the configured maximum number of CCs is 8, or in the case that the maximum number of CCs that may be configured is 8 whereas the number of CCs actually configured is any number among 2˜7, the feedback information sending module can be further configured to: in the case that the total number of ACKs is 0, send no data; in the case that the total number of ACKs is greater than 0 and less than 5, feed back the total number of ACKs to the eNB by utilizing the QPSK modulating mode on the PUCCH resources corresponding to the carrier with the minimum index number among the downlink carriers which have been received correctly; in the case that the total number of ACKs is greater than or equal to 5 and is less than or equal to 8, feed back the total number of ACKs to the eNB by utilizing the QPSK modulating mode on the PUCCH resources corresponding to the carrier with the maximum index number among the downlink carriers which have been received correctly.

In the present embodiment, the QPSK constellation points utilized when the total number of the multiple ACKs equals 1 are the same as the QPSK constellation points utilized when the total number of the multiple ACKs equals 5; the QPSK constellation points utilized when the total number of the multiple ACKs equals 2 are the same as the QPSK constellation points utilized when the total number of the multiple ACKs equals 8; the QPSK constellation points utilized when the total number of the multiple ACKs equals 3 are the same as the QPSK constellation points utilized when the total number of the multiple ACKs equals 7; the QPSK constellation points utilized when the total number of the multiple ACKs equals 4 are the same as the QPSK constellation points utilized when the total number of the multiple ACKs equals 6.

Referring to FIG. 7 which shows a structural schematic diagram of a base station according to an embodiment of the invention, the base station is applicable to a multi-carrier wireless communication system (such as an LTE-Advanced system), the base station can specifically include: a sending module 701, which is configured to send data to a user equipment on multiple downlink CCs; and a receiving module 702, which is configured to receive the feedback information of the downlink data sent by the use equipment. The feedback information of the downlink data includes the total number of the multiple ACKs corresponding to the multiple CCs; the user equipment selects corresponding PUCCH resources to send the feedback information of the downlink data to the eNB, according to correspondence relationship between the total number of the ACKs and the maximum CC index number that is configured.

In the case that the maximum number of CCs configured by the multi-carrier wireless communication system is 5 or in the case that the maximum number of CCs that may be configured is 5 whereas the number of CCs actually configured is any number among 2˜4, and in the case that the maximum number of CCs configured by the multi-carrier wireless communication system is 8 or in the case that the maximum number of CCs that may be configured is 8 whereas the number of CCs actually configured is any number among 2˜7, the base station can also include: a first obtaining module, which is configured to obtain, according to the received QPSK constellation points, the feedback information about reception of data that corresponds to the QPSK constellation points, wherein the feedback information includes the total number of ACKs and the information of the CC with the minimum or maximum index number among the downlink CCs received correctly by the user equipment. In the case that the configured maximum CC index number is 3, the base station can also include: a second obtaining module, which is configured to obtain, according to the received BPSK constellation points, the feedback information about reception of data that corresponds to the BPSK constellation points, wherein the feedback information includes the total number of ACKs and the information of the CC with the minimum or maximum index number among the downlink CCs received correctly by the user equipment.

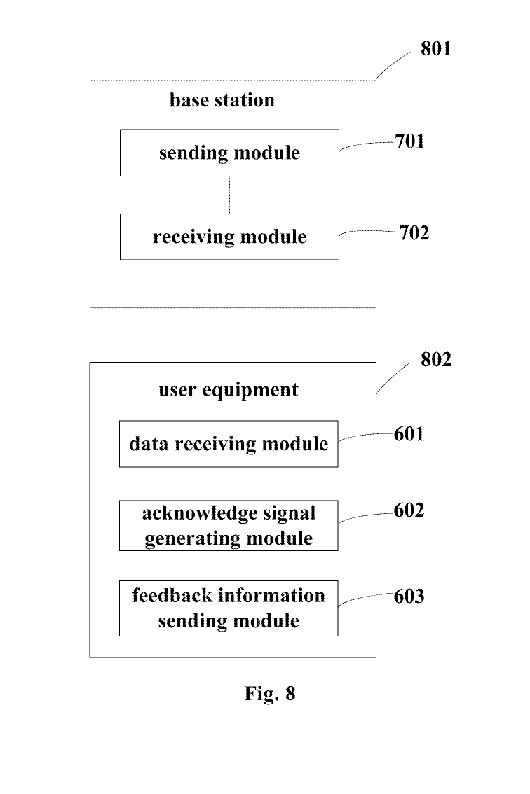

Referring to FIG. 8 which is a structural schematic diagram of a multi-carrier wireless communication system according to an embodiment of the invention, the system can specifically include: a base station 801, which is configured to send data to a user equipment on multiple downlink CCs and receive feedback information of downlink data sent by the user equipment, wherein the feedback information of the downlink data includes the total number of multiple ACKs corresponding to the multiple CCs, and the user equipment selects corresponding PUCCH resources to send the feedback information of the downlink data to the eNB according to the correspondence relationship between the total number of the multiple ACKs and the configured maximum CC index number; a user equipment 802, which is configured to detect whether the data are received correctly on the multiple downlink CCs respectively, and generates multiple ACKs corresponding to the multiple CCs according to detection results; and select PUCCH resources to send the feedback information of the downlink data to the eNB according to correspondence relationship between the total number of the multiple ACKs and the configured maximum CC index number, wherein the feedback information includes the total number of the multiple ACKs.

It should be illustrated that, in the multi-carrier wireless communication system of the present embodiment, the base station 801 can specifically include: a sending module 701, which is configured to send data to a user equipment on multiple downlink CCs; and a receiving module 702, which is configured to receive feedback information of the downlink data sent by the user equipment. The feedback information of the downlink data includes the total number of the multiple ACKs corresponding to the multiple CCs; the user equipment selects corresponding PUCCH resources to send the feedback information of the downlink data to the eNB, according to correspondence relationship between the total number of the multiple ACKs and the configured maximum CC index number.

The user equipment can specifically include: a data receiving module 601, which is configured to receive data that is sent on multiple downlink CCs by a base station eNB; an acknowledge signal generating module 602, which is configured to detect whether the data are received correctly on the multiple downlink CCs respectively and generate ACKs corresponding to the multiple CCs according to detection results; a feedback information sending module 603, which is configured to select corresponding PUCCH resources to send the feedback information of the downlink data to the eNB according to correspondence relationship between the total number of the ACKs corresponding to the multiple CCs and the maximum CC index number that is configured; wherein the feedback information includes the total number of the ACKs.

Although the invention and its advantages are illustrated in detail, it should be understood that various modifications, alternatives and variations can be made without deviation from the spirit and the scope of the invention defined by the appended claims. Furthermore, in the application, terms “include”, “comprise” or other variations thereof are intended to cover the non-exclusive including, so that the process, method, article or device including a series of elements not only include the described elements, but also include other elements that are not cited definitely, or also include the inherent elements of the process, method, article or device. In the case that there is no more limitations, the elements defined by a phrase “including a . . . ” does not exclude that there are other same elements in the process, method, article or device which include the described elements.

1. A method for sending feedback information of downlink data, which is applied to a user equipment in a multi-carrier wireless communication system, comprising:
receiving downlink data sent on a plurality of downlink component carriers by a base station;
detecting whether the downlink data are correctly received on the plurality of downlink component carriers respectively, and generating a plurality of acknowledge signals corresponding to the plurality of component carriers according to detection results; and
selecting corresponding Physical Uplink Control CHannel (PUCCH) resources to send the feedback information of the downlink data to the base station according to correspondence relationship between the total number of the plurality of acknowledge signals and the maximum Component Carrier index number that is configured, wherein the feedback information comprises the total number of the plurality of acknowledge signals.

2. The method for sending feedback information of downlink data according to claim 1, wherein in the case that the maximum number of component carriers configured by the multi-carrier wireless communication system is 5, or in the case that the maximum number of component carriers that are able to be configured by the multi-carrier wireless communication system is 5 whereas the number of component carriers actually configured is any number among 2˜4, the selecting corresponding PUCCH resources to send the feedback information of the downlink data to the base station comprises:
in the case that the total number of the acknowledge signals equals 5, feeding back the total number of the acknowledge signals to the base station by utilizing a Quaternary Phase Shift Keying (QPSK) modulating mode on PUCCH resources corresponding to a component carrier with the maximum index number among the downlink component carriers which have been received correctly;
in the case that the total number of the acknowledge signals is greater than 0 and less than 5, feeding back the total number of the acknowledge signals to the base station by utilizing a QPSK modulating mode on PUCCH resources corresponding to a component carrier with the minimum index number among the downlink component carriers which have been received correctly; and
in the case that the total number of the acknowledge signals is 0, sending no data.

3. The method for sending feedback information of downlink data according to claim 2, wherein QPSK constellation points utilized when the total number of the acknowledge signals corresponding to the plurality of downlink component carriers equals 1 are different from QPSK constellation points utilized when the total number of the acknowledge signals is any number among 2˜5.

4. The method for sending feedback information of downlink data according to claim 3, wherein QPSK constellation points utilized when the total number of the acknowledge signals equals 5 are the same as the QPSK constellation points utilized when the total number of the acknowledge signals is a number among 2˜4.

5. The method for sending feedback information of downlink data according to claim 1, wherein in the case that the maximum number of component carriers configured by the multi-carrier wireless communication system is 3, a Binary Phase Shift keying (BPSK) modulating mode is utilized, and the selecting corresponding PUCCH resources to send the feedback information of the downlink data to the base station comprises:
in the case that the total number of the acknowledge signals equals 3, feeding back the total number of the acknowledge signals to the base station by utilizing a BPSK modulating mode on PUCCH resources corresponding to a component carrier with the maximum index number among the downlink component carriers which have been received correctly;
in the case that the total number of the acknowledge signals is greater than 0 and less than 3, feeding back the total number of the acknowledge signals to the base station by utilizing a BPSK modulating mode on PUCCH resources corresponding to a component carrier with the minimum index number among the downlink component carriers which have been received correctly; and
in the case that the total number of the acknowledge signals is 0, sending no data.

6. The method for sending feedback information of downlink data according to claim 5, wherein BPSK constellation points utilized when the total number of the acknowledge signals corresponding to the plurality of downlink component carriers equals 1 are different from BPSK constellation points utilized when the total number of the acknowledge signals is any number among 2˜3.

7. The method for sending feedback information of downlink data according to claim 1, wherein in the case that the maximum number of component carriers configured by the multi-carrier wireless communication system is 8, or in the case that the maximum number of the component carriers that are able to be configured by the multi-carrier wireless communication system is 8 whereas the number of component carriers actually configured is any number among 2˜7, a Quaternary Phase Shift Keying (QPSK) modulating mode is utilized, and the selecting corresponding PUCCH resources to send the feedback information of the downlink data to the base station comprises:
in the case that the total number of the acknowledge signals is 0, sending no data;
in the case that the total number of the acknowledge signals is greater than 0 and less than 5, feeding back the total number of the acknowledge signals to the base station by utilizing the QPSK modulating mode on PUCCH resources corresponding to a component carriers with the minimum index number among the downlink component carriers which have been received correctly; and
in the case that the total number of the acknowledge signals is greater than or equal to 5 and is less than or equal to 8, feeding back the total number of the acknowledge signals to the base station by utilizing the QPSK modulating mode on PUCCH resources corresponding to a component carrier with the maximum index number among the downlink component carriers which have been received correctly.

8. The method for sending feedback information of downlink data according to claim 7, wherein the QPSK constellation points utilized when the total number of the plurality of acknowledge signals equals 1 are the same as the QPSK constellation points utilized when the total number of the plurality of acknowledge signals equals 5;
the QPSK constellation points utilized when the total number of the plurality of acknowledge signals equals 2 are the same as the QPSK constellation points utilized when the total number of the plurality of acknowledge signals equals 8;
the QPSK constellation points utilized when the total number of the plurality of acknowledge signals equals 3 are the same as the QPSK constellation points utilized when the total number of the plurality of acknowledge signals equals 7; and
the QPSK constellation points utilized when the total number of the plurality of acknowledge signals equals 4 are the same as the QPSK constellation points utilized when the total number of the plurality of acknowledge signals equals 6.

9. A user equipment applicable to a multi-carrier wireless communication system, comprising:
a data receiving module configured to receive downlink data sent on a plurality of downlink component carriers by a base station;
an acknowledge signal generating module configured to detect whether the downlink data are correctly received on the plurality of downlink component carriers respectively, and generate a plurality of acknowledge signals corresponding to the plurality of component carriers according to detection results; and
a feedback information sending module configured to select corresponding Physical Uplink Control CHannel (PUCCH) resources to send the feedback information of the downlink data to the base station, according to correspondence relationship between the total number of the plurality of acknowledge signals and the maximum component carrier index number that is configured, wherein the feedback information comprises the total number of the plurality of acknowledge signals.

10. The user equipment according to claim 9, wherein in the case that the maximum number of component carriers configured by the multi-carrier wireless communication system is 5, or in the case that the maximum number of component carriers that are able to be configured by the multi-carrier wireless communication system is 5 whereas the number of component carriers actually configured is any number among 2˜4, the feedback information sending module is further configured to:
in the case that the total number of the acknowledge signals equals 5, feed back the total number of the acknowledge signals to the base station by utilizing a Quaternary Phase Shift Keying (QPSK) modulating mode on PUCCH resources corresponding to a component carrier with the maximum index number among the downlink component carriers which have been received correctly;
in the case that the total number of the acknowledge signals is greater than 0 and less than 5, feed back the total number of the acknowledge signals to the base station by utilizing the QPSK modulating mode on PUCCH resources corresponding to a component carrier with the minimum index number among the downlink component carriers which have been received correctly; and
in the case that the total number of the acknowledge signals is 0, send no data.

11. The user equipment according to claim 9, wherein in the case that the maximum index number of component carriers configured by the multi-carrier wireless communication system is 3, the feedback information sending module is further configured to:
in the case that the total number of the acknowledge signals equals 3, feed back the total number of the acknowledge signals to the base station by utilizing a Binary Phase Shift keying (BPSK) modulating mode on PUCCH resources corresponding to a component carrier with the maximum index number among the downlink component carriers which have been received correctly;
in the case that the total number of the acknowledge signals is greater than 0 and less than 3, feed back the total number of the acknowledge signals to the base station by utilizing the BPSK modulating mode on PUCCH resources corresponding to a component carrier with the minimum index number among the downlink component carriers which have been received correctly; and
in the case that the total number of the acknowledge signals is 0, send no data.

12. The user equipment according to claim 9, wherein in the case that the maximum number of component carriers configured by the multi-carrier wireless communication system is 8, or in the case that the maximum number of component carriers that are able to be configured by the multi-carrier wireless communication system is 8 whereas the number of component carriers actually configured is any number among 2˜7, the feedback information sending module is further configured to:
in the case that the total number of the acknowledge signals is 0, send no data;
in the case that the total number of the acknowledge signals is greater than 0 and less than 5, feed back the total number of the acknowledge signals to the base station by utilizing a Quaternary Phase Shift Keying (QPSK) modulating mode on PUCCH resources corresponding to a component carrier with the minimum index number among the downlink component carriers which have been received correctly; and
in the case that the total number of the acknowledge signals is greater than or equal to 5 and is less than or equal to 8, feed back the total number of the acknowledge signals to the base station by utilizing the QPSK modulating mode on PUCCH resources corresponding to a component carrier with the maximum index number among the downlink component carriers which have been received correctly.

13. A method for receiving feedback information of downlink data, which is applied to a base station in a multi-carrier wireless communication system, comprising:
sending downlink data to a user equipment on a plurality of downlink component carriers;
receiving feedback information of the downlink data sent by the user equipment, wherein the feedback information of the downlink data comprises the total number of a plurality of acknowledge signals corresponding to the plurality of component carriers; the user equipment selects corresponding Physical Uplink Control CHannel (PUCCH) resources to send the feedback information of the downlink data to the base station, according to correspondence relationship between the total number of the plurality of acknowledge signals and the maximum component carrier index number that is configured.

14. The method for receiving feedback information of downlink data according to claim 13, wherein in the case that the maximum number of component carriers configured by the multi-carrier wireless communication system is 5, or in the case that the maximum number of component carriers that are able to be configured by the multi-carrier wireless communication system is 5 whereas the number of component carriers actually configured is any number among 2˜4; or in the case that the maximum number of component carriers configured by the multi-carrier wireless communication system is 8, or in the case that the maximum number of component carriers that are able to be configured by the system is 8 whereas the number of component carriers actually configured is any number among 2˜7, the method further comprises:
obtaining, according to the received Quaternary Phase Shift Keying (QPSK) constellation points, the feedback information about reception of the downlink data that corresponds to the QPSK constellation points, wherein the feedback information comprises the total number of the acknowledge signals as well as information of the component carrier with the minimum or maximum index number among the downlink component carriers which have been received correctly by the user equipment.

15. The method for receiving feedback information of downlink data according to claim 13, wherein in the case that the maximum number of the component carriers configured by the multi-carrier wireless communication system equals 3, the method further comprises:
obtaining, according to the received Binary Phase Shift keying (BPSK) constellation points, the feedback information about reception of the downlink data that corresponds to the BPSK constellation points, wherein the feedback information comprises the total number of the acknowledge signals as well as information of the component carrier with the minimum or maximum index number among the downlink component carriers which have been received correctly by the user equipment.

16. A base station applicable to a multi-carrier wireless communication system, comprising:
a sending module configured to send downlink data to a user equipment on a plurality of downlink component carriers;
a receiving module is configured to receive feedback information of the downlink data sent by the user equipment, wherein the feedback information of the downlink data comprises the total number of a plurality of acknowledge signals corresponding to the plurality of component carriers; the user equipment selects corresponding Physical Uplink Control CHannel (PUCCH) resources to send the feedback information of the downlink data to the base station, according to correspondence relationship between the total number of the plurality of acknowledge signals and the maximum component carrier index number that is configured.

17. The base station according to claim 16, further comprising:
a first obtaining module configured to obtain, according to the received Quaternary Phase Shift Keying (QPSK) constellation points, feedback information about reception of the downlink data that corresponds to the QPSK constellation points, wherein the feedback information comprises the total number of the acknowledge signals as well as information of a component carrier with the minimum or maximum index number among the downlink component carriers which have been received correctly by the user equipment.

18. The base station according to claim 16, further comprising:
a second obtaining module configured to obtain, according to the received Binary Phase Shift keying (BPSK) constellation points, feedback information about reception of the downlink data corresponding to the BPSK constellation points, wherein the feedback information comprises the total number of the acknowledge signals as well as information of a component carrier with the minimum or maximum index number among the downlink component carriers which have been received correctly by the user equipment.

19. A multi-carrier wireless communication system, comprising:
a base station configured to send downlink data to a user equipment on a plurality of downlink component carriers, and receive feedback information of the downlink data sent by the user equipment, wherein the feedback information of the downlink data comprises the total number of a plurality of acknowledge signals corresponding to the plurality of component carriers; the user equipment selects corresponding Physical Uplink Control CHannel (PUCCH) resources to send the feedback information of the downlink data to the base station, according to correspondence relationship between the total number of the plurality of acknowledge signals and the maximum component carrier index number that is configured;
the user equipment configured to detect whether the data are correctly received on the plurality of downlink component carriers respectively, generate a plurality of acknowledge signals corresponding to the plurality of component carriers according to detection results, and select corresponding PUCCH resources to send the feedback information of the downlink data to the base station, according to correspondence relationship between the total number of the plurality of acknowledge signals and the maximum component carrier index number that is configured; wherein the feedback information comprises the total number of the plurality of acknowledge signals.
